(19) United States
(12) Patent Application Publication
(10) Pub. No.: US 2023/0222998 A1
(43) Pub. Date: Jul. 13, 2023

(54) INFORMATION PROCESSING APPARATUS, INFORMATION PROCESSING METHOD, AND PROGRAM

(71) Applicant: SONY GROUP CORPORATION, TOKYO (JP)

(72) Inventors: SHIGETOSHI HAYASHI, TOKYO (JP); YOSHIYUKI KURODA, TOKYO (JP); TETSUNORI ITABASHI, TOKYO (JP); KOHEI ASADA, TOKYO (JP); KOYA SATO, TOKYO (JP); MASAKI KAMATA, TOKYO (JP)

(21) Appl. No.: 18/001,172

(22) PCT Filed: May 25, 2021
(86) PCT No.: PCT/JP2021/019756

§ 371 Date: Dec. 8, 2022

(30) Foreign Application Priority Data
Jun. 16, 2020 (JP) 2020-104047

(51) Int. Cl. G10K 11/178

(52) U.S. Cl. CPC G10K 11/178

(57) ABSTRACT

Provided is an information processing apparatus including a control unit configured to control a gain of a drive signal for an actuator that is used for vibration control of an object to be controlled, according to a processing result of adaptive processing using an output signal from a sensor and the drive signal for the actuator that have been decimated, the sensor being configured to detect vibration of the object to be controlled, the drive signal being generated according to the output signal from the sensor.

### TECHNICAL FIELD

The present disclosure relates to an information processing apparatus, an information processing method, and a program.

### BACKGROUND ART

In recent years, as a technology for creating a quiet space, a technology called space noise control (NC) has been attracting attention. Space noise control is roughly classified into active control that controls noise by using drive units such as speakers and passive control that controls noise by using, not the drive units, but sound absorbing materials, sound insulating materials, damping materials, anti-vibration materials, or the like or by shape optimization. It has been known that active control is effective means for a low-frequency band in which passive control is considered not effective so much (specifically, a frequency band in which noise is difficult to control by passive control due to low efficiency, an increase in size, high cost, and the like).

In a related-art headphone NC, for example, noise is reduced by active control with use of a microphone configured to collect sound as a sensor and a speaker for controlling, as an object to be controlled, noise at an eardrum position.

Meanwhile, noise is caused by acoustic emission due to vibration of an object in some cases. In this case, the object causing acoustic emission itself is regarded as an object to be controlled, and the vibration of the object to be controlled itself is actively controlled, thereby making it possible to support a wider control space. PTL 1 described below proposes an in-car noise canceling apparatus capable of reducing in-car noise.

### Citation List

### Patent Literature

[PTL 1]

Japanese Patent Laid-open No. 2006-88804

### SUMMARY

### Technical Problem

However, an object to be controlled, which is a target, generally causes complex vibration depending on various conditions such as the material and the shape. Hence, a more effective noise control technology capable of dealing with such complex vibration has been demanded.

It is an object of the present disclosure to provide an information processing apparatus, an information processing method, and a program capable of implementing enhanced noise control performance.

### Solution to Problem

The present disclosure is, for example, an information processing apparatus including a control unit configured to control a gain of a drive signal for an actuator that is used for vibration control of an object to be controlled, according to a processing result of adaptive processing using an output signal from a sensor and the drive signal for the actuator that have been decimated, the sensor being configured to detect vibration of the object to be controlled, the drive signal being generated according to the output signal from the sensor.

The present disclosure is, for example, an information processing apparatus including a control unit configured to perform control of receiving, by a communication circuit, from a child apparatus configured to control a gain of a drive signal for an actuator that is used for vibration control of an object to be controlled, an output signal from a sensor and the drive signal for the actuator that have been decimated, the sensor being configured to detect vibration of the object to be controlled, the drive signal being generated according to the output signal from the sensor, performing adaptive processing by using the received information, and transmitting, by the communication circuit, information for controlling the gain of the drive signal for the actuator based on a processing result of the adaptive processing to the child apparatus.

The present disclosure is, for example, an information processing method including, by a control unit, controlling a gain of a drive signal for an actuator that is used for vibration control of an object to be controlled, according to a processing result of adaptive processing using an output signal from a sensor and the drive signal for the actuator that have been decimated, the sensor being configured to detect vibration of the object to be controlled, the drive signal being generated according to the output signal from the sensor.

The present disclosure is, for example, a program for causing a computer to execute an information processing method including, by a control unit, controlling a gain of a drive signal for an actuator that is used for vibration control of an object to be controlled, according to a processing result of adaptive processing using an output signal from a sensor and the drive signal for the actuator that have been decimated, the sensor being configured to detect vibration of the object to be controlled, the drive signal being generated according to the output signal from the sensor.

### BRIEF DESCRIPTION OF DRAWINGS

FIG. 1 is a diagram illustrating classification of sensors and objects to be controlled in noise control of active control.

FIG. 2 is a diagram illustrating shapes of vibration modes of a panel and measurement result examples.

FIG. 3 is a diagram illustrating options in implementing multiple channels (decentralized control and centralized control).

FIG. 4 is a diagram illustrating features of centralized control and decentralized control.

FIG. 5 is a diagram illustrating configuration examples of mutually independent decentralized control systems.

FIG. 6 is a diagram illustrating a configuration example in a case where overall optimization with a self-tuning algorithm is applied.

FIG. 7 is a diagram illustrating limitations on the case where overall optimization with the self-tuning algorithm is applied.

FIG. 8 is a diagram illustrating processing required to be performed at a high speed and processing not required to have a real-time characteristic.

FIG. 9 is an explanatory diagram illustrating advantages of a noise control system according to a first embodiment.

FIG. 10 is a diagram illustrating a configuration example of the noise control system according to the first embodiment.

FIG. 11 is a diagram illustrating a configuration example of module information.

FIG. 12 is a sequence diagram illustrating an exemplary flow of overall processing in the noise control system according to the first embodiment.

FIG. 13 is a flowchart illustrating an exemplary flow of transmission mode processing.

FIG. 14 is a flowchart illustrating an exemplary flow of adjustment mode processing.

FIG. 15 is a flowchart illustrating an exemplary flow of adaptive processing.

FIG. 16 is a sequence diagram illustrating another exemplary flow of the overall processing in the noise control system according to the first embodiment.

FIG. 17 is a diagram illustrating a configuration example of a noise control system according to a second embodiment.

FIG. 18 is an explanatory diagram illustrating feedforward and feedback noise canceling.

FIG. 19 is a diagram illustrating a configuration example of a signal processing block according to a third embodiment.

FIG. 20 is a diagram illustrating a configuration example of a noise control system according to the third embodiment.

FIG. 21 is a diagram illustrating a configuration example of a noise control system according to a fourth embodiment.

FIG. 22 is a diagram illustrating a configuration example of a noise control system according to a fifth embodiment.

### DESCRIPTION OF EMBODIMENTS

Now, embodiments and the like of the present disclosure are described with reference to the drawings. Note that the description is made in the following order.
<1. First Embodiment>
<2. Second Embodiment>
<3. Third Embodiment>
<4. Fourth Embodiment>
<5. Fifth Embodiment>
<6. Modified Example>

The embodiments and the like described below are preferred specific examples of the present disclosure, and the contents of the present disclosure are not limited to the embodiments and the like. Note that, in the following description, components having substantially the same functional configuration are denoted by the same reference signs to appropriately omit the overlapping description.

### 1. First Embodiment

### [Problems to Be Considered]

First, problems to be considered in the embodiments are described to facilitate understanding of the embodiments.

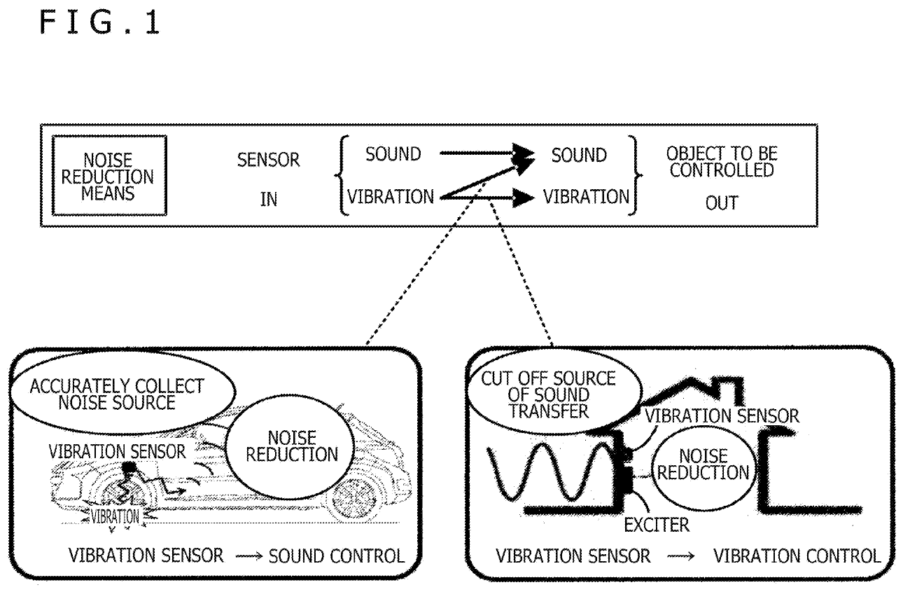

FIG. 1 illustrates classification of sensors and objects to be controlled in noise control of active control. Noise reduction techniques are roughly classified into two, for example. The first one is a technique that receives (detects) sound by a sound sensor such as a microphone and outputs sound from an object to be controlled such as a speaker (sound control). The second one is a technique that receives vibration by a vibration sensor such as an accelerometer and outputs sound from an object to be controlled such as a speaker. The third one is a technique that receives vibration by a vibration sensor such as an accelerometer and controls the vibration of an object to be controlled such as a panel with excitation by an actuator.

In a case where noise is caused by acoustic emission due to the vibration of an object, as described above, the vibration of the object itself is actively controlled to make it possible to support a wider control space (vibration sensor—vibration control of FIG. 1). However, an object to be controlled, which is a target, has a complex vibration mode that is determined depending on various conditions such as the material and the shape.

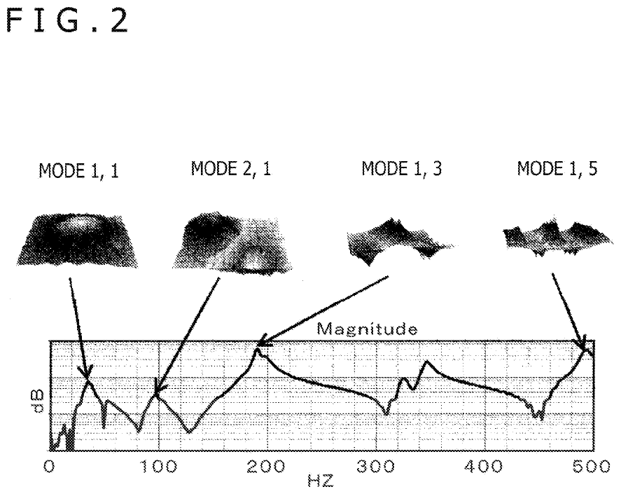

FIG. 2 illustrates shapes of vibration modes of a panel and measurement result examples. In FIG. 2, the vertical axis indicates amplitude value (dB), and the horizontal axis indicates frequency (Hz). As is found also from FIG. 2, an object has a large amplitude value at a frequency at which a vibration mode occurs (for example, in Mode 1, 1, there is a large amplitude in a central part). Thus, noise to be emitted can be reduced by efficiently controlling a vibration mode.

However, for example, in a closed space defined by multiple panels such as a passenger compartment, the panels that are the components form a complex vibration mode. To control such a complex vibration mode, an actuator that is a control device is required to also excite a complex vibration mode.

To achieve this, multiple actuators are preferably placed in a space decentrally since such a placement leads to performance enhancement with a high possibility. However, when the number of actuators or sensors is increased, there arise problems of calculation cost and wiring-related problems. Now, this is specifically described.

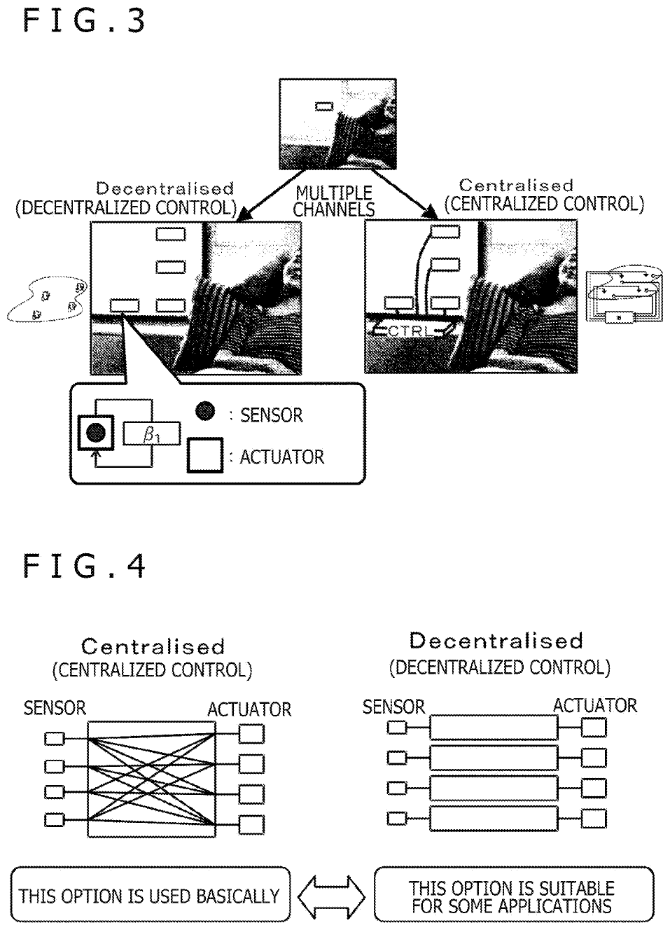

As methods that use multiple actuators, specifically, control systems such as centralized control and decentralized control are given. FIG. 3 is a diagram illustrating options in a case where multiple channels are implemented, namely, in a case where multiple actuators are used (decentralized control and centralized control). Here, the centralized control generally indicates a system configured to perform control after gathering sensor information in a controller (CTRL) once in a concentrative manner, and the decentralized control generally indicates a system that includes, as units, modules each including a sensor and an actuator and that does not use mutual information between the modules.

FIG. 4 is a diagram illustrating features of centralized control and decentralized control. As illustrated in the figure, in centralized control, cross paths can be used between sensors and actuators, so that complex processing can be performed to aim at the highest performance. However, the cost of a calculation including the cross paths is high. Meanwhile, in decentralized control, although the calculation cost is low, the highest performance is difficult to obtain in some cases since cross paths cannot be used between sensors and actuators. Hence, centralized control is often used to enhance the performance of noise control in general. For example, as a technique for reducing vibration-based noise in an airplane by centralized control, there has been proposed a technique that uses 245 channels (that is, 245 actuators), connects each module to a CAN-bus, and generates cancellation signals by the actuators with use of mutual information.

Meanwhile, it is possible that centralized control is not suitable for some cases. Specifically, the following three cases are given. The first case is a case where a user may install a control module, namely, an apparatus including an actuator, at any location. In other words, this is a case where a usage environment (a shape, a location, or the like) is unknown in advance, so that appropriate control cannot be guaranteed. The second case is a case where an application requires transparency, for example, and the wiring of a system spoils the appearance. For example, this is a case where a control module is attached or installed on a transparent window and the appearance is deteriorated due to the wiring. The third case is a case where it is desirable that everything be completed with signal processing in module units with a low computational resource, that is, a case where autonomy is emphasized and a processing apparatus such as an expensive processor is not used.

In this way, decentralized control is more suitable for some cases depending on supposed applications. Thus, in the embodiments and the like described below, a system configured to implement enhanced noise control performance in control based on decentralized control described above that uses multiple actuators is proposed.

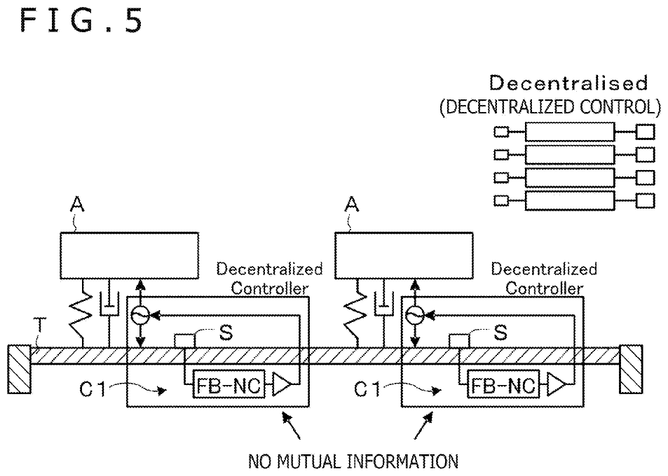

Here, a decentralized control noise control system (hereinafter referred to as a decentralized control system) is described. FIG. 5 is a diagram illustrating configuration examples of mutually independent decentralized control systems. Note that here, as a decentralized control system, a module with a feedback noise canceling system (FB-NC system), including an actuator A, a sensor S, and a signal processing circuit C1, is supposed.

As described above, each module includes the controller (FB-NC system) as a component of the decentralized control system but does not have an index for the overall optimization of a vibration level of an object T to be controlled since mutual information is not shared between the modules. That is, since no mutual information is shared between the modules and hence there is no index for overall optimization, a reference for overall control is unknown.

### [Overview of Noise Control System]

Now, an overview of a noise control system according to a first embodiment is described. In view of the circumstances described above, in the present embodiment and the like, while low computational cost and processing in module units (specifically, processing free from troublesome wiring), which are advantages of decentralized control, are used, mutual information sharing, which is an advantage of centralized control, can be performed, to thereby implement enhanced noise control performance.

Here, also in the system configured to complete signal processing in module units as illustrated in FIG. 5, overall optimization can be performed without the centralized management of sensor information by introducing some evaluation functions for overall optimization and performing signal processing with use of signal processing in module units. It is considered that the overall level of vibration (vibration for cancellation) can be maximized by introducing an evaluation function such as “maximizing the efficiency of a conversion from vibration into thermal energy by each actuator,” for example. In the following description, this technique is referred to as a self-tuning algorithm.

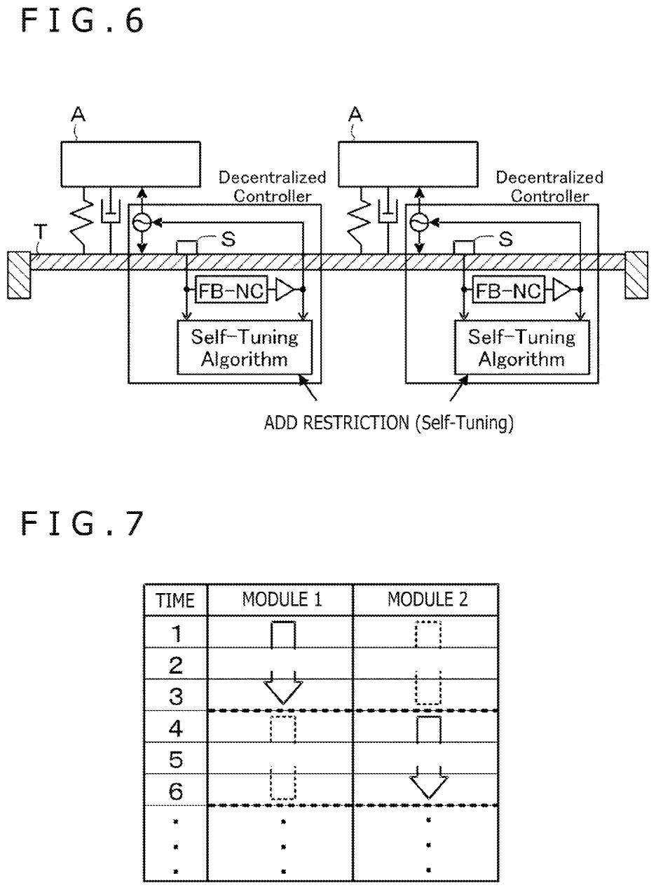

FIG. 6 and FIG. 7 are diagrams illustrating a case where overall optimization with the self-tuning algorithm is applied. As illustrated in FIG. 6, applying the self-tuning algorithm to each module provides an advantage in that signal processing can be completed in the module. Meanwhile, restriction that the number of modules allowed to execute tuning to minimize the vibration energy of the overall object T to be controlled at the same time is one is added. That is, as illustrated in FIG. 7, restriction that, while a module 1 is performing tuning, another module (module 2) does not perform tuning is added. Thus, it is difficult to simply adapt the algorithm described above to a modularized decentralized control system as it is.

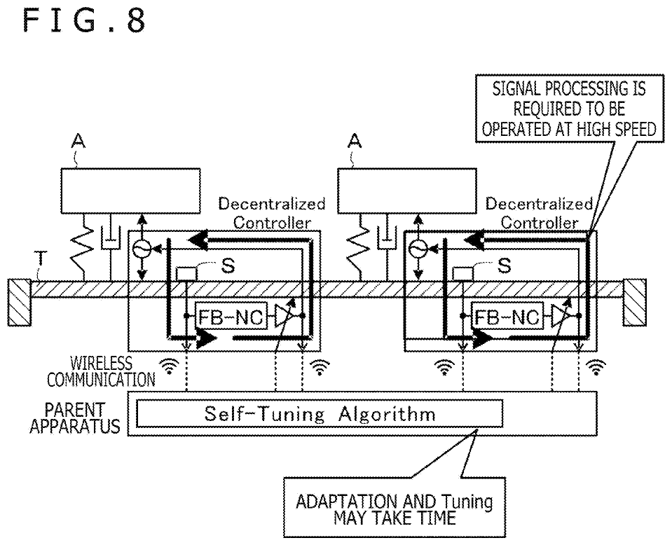

Here, a real-time characteristic of signal processing is considered. FIG. 8 is a diagram illustrating processing required to be performed at a high speed and processing not required to have a real-time characteristic. In a circuit configured to perform noise canceling processing (processing by the FB-NC system) in a module (a processing unit required to be operated at a high speed of FIG. 8), a delay of the system directly leads to a system failure such as a degradation in performance or acoustic feedback. Thus, noise canceling processing is required to have a real-time characteristic and hence required to be performed at a high speed.

Meanwhile, such processing as adaptive processing with an evaluation function for overall optimization described above (for example, self-tuning) is not required to be performed in real-time. Hence, in the present embodiment, a processing block required to be operated at a high speed and a processing block not required to have a real-time characteristic are separately operated. This eliminates, even in a signal processing system in module units, the need for centralized control that centrally manages sensor information with wired connection, which has a small delay, to share mutual information. That is, mutual information can be shared with use of wireless communication while processing in module units is achieved.

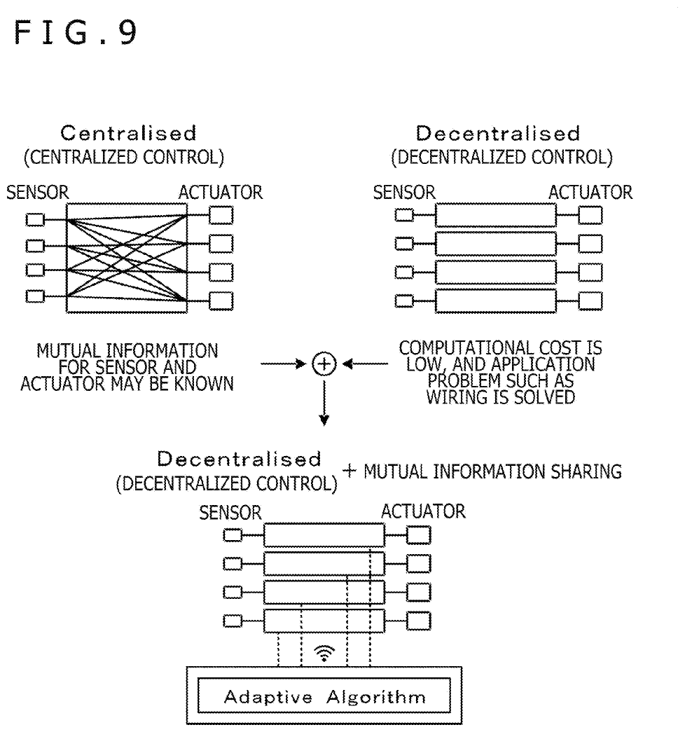

FIG. 9 is an explanatory diagram illustrating advantages of the noise control system according to the present embodiment. In the noise control system according to the present embodiment, the processing block not required to have a real-time characteristic (adaptive processing with an adaptive algorithm in the example illustrated in FIG. 9) is separated from the processing block in which noise canceling processing is performed by using wireless processing, to thereby obtain both the advantages of decentralized control and the advantage of centralized control described above.

### [Configuration Example of Noise Control System]

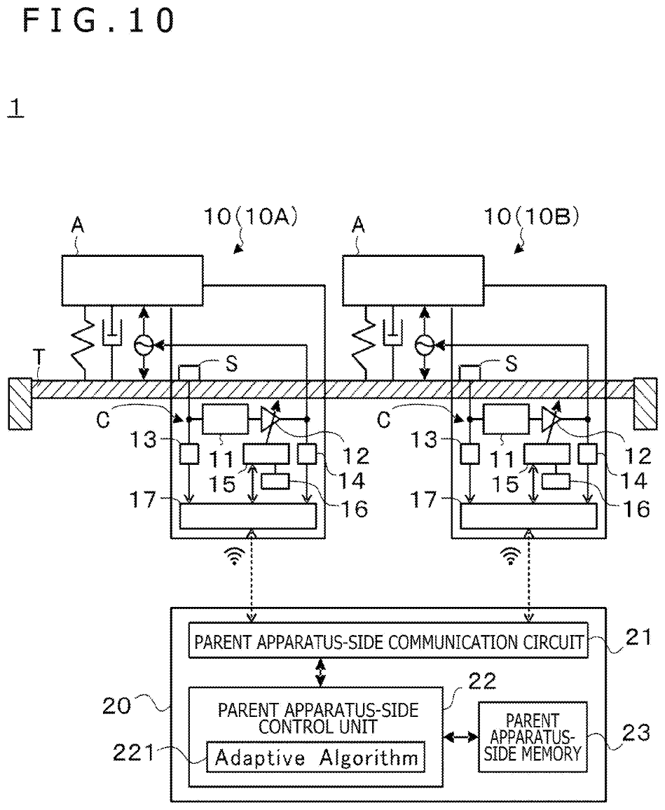

Next, a configuration of the noise control system according to the present embodiment is described in detail. FIG. 10 illustrates a configuration example of the noise control system according to the present embodiment (noise control system 1). The noise control system 1 according to the present embodiment includes child apparatuses (terminal apparatuses) 10 and a parent apparatus (server apparatus) 20 configured separately from the child apparatuses 10. Note that the number of child apparatuses 10 in the noise control system 1 is not particularly limited to any number although the more the child apparatuses 10, the higher the noise control performance. In the present embodiment, to make the description easier to understand, a case where the number of child apparatuses 10 is two (a case where two child apparatuses 10A and 10B are included) is described as an example. This similarly applies to the other embodiments and the like.

The noise control system 1 is supposed to be used with the child apparatuses 10 installed on the object T to be controlled whose vibration is to be controlled. The object T to be controlled is an object that may cause vibration to cause noise by acoustic emission and includes, for example, a plate-like solid object (panel) such as a glass plate or a metal plate. Examples of the object T to be controlled include frames or windows of moving bodies (specifically, vehicles) such as cars and airplanes and frames or windows of buildings. With the above, noise in the space inside a vehicle or building can be reduced.

### [Configuration Example of Child Apparatus]

The child apparatuses 10 (vibration control modules) are each a single module (a module including the sensor S and the actuator A) configured to operate as a noise canceling apparatus alone. When being used, the child apparatus 10 is installed on a surface on the side of a space in which noise canceling is desired (hereinafter referred to as a target surface) of the object T to be controlled, for example. With this, noise can efficiently be reduced. The child apparatus 10 includes a portable casing, for example, and can be removably mountable on the object T to be controlled. This can lead to an increased degree of freedom of installation of the child apparatus 10.

The child apparatuses 10 each include the sensor S, the actuator A, and the signal processing circuit C. The sensor S detects the vibration of the object T to be controlled and includes an accelerometer, for example. The sensor S is mounted on the object T to be controlled (specifically, the target surface of the object T to be controlled), for example. With the sensor S mounted on the target surface, vibration can efficiently be detected. The sensor S is connected to the signal processing circuit C, and output from the sensor S, that is, sensor information (output signal) is input to the signal processing circuit C.

The actuator A controls the vibration of the object T to be controlled and includes an inertial actuator, for example. Note that the actuator A may include another type of actuator such as a piezoelectric actuator. The actuator A is mounted on the object T to be controlled (specifically, the target surface of the object T to be controlled) to be capable of controlling the object T to be controlled to enter a predetermined vibration state, for example. With the actuator A mounted on the target surface, noise can efficiently be reduced. The actuator A is connected to the signal processing circuit C and drives, with an excitation signal (that is, drive signal) input from the signal processing circuit C, to excite the object T to be controlled.

The signal processing circuit C includes an FB-NC unit 11 and an amplifier 12 that perform noise canceling processing involving vibration control together with the sensor S and the actuator A. The FB-NC unit 11 is a circuit for feedback noise control (FB-NC) processing and includes an FB-NC digital filter, for example. The FB-NC unit 11 is connected to the sensor S and generates, on the basis of sensor information input from the sensor S, a drive signal (excitation signal) for the actuator A that is used for the vibration control of the object T to be controlled. Specifically, the FB-NC unit 11 performs signal processing for vibration cancellation on sensor information to generate a cancellation signal as an excitation signal. A cancellation signal is a signal opposite in phase to an input signal, for example. The FB-NC unit 11 is connected to the amplifier 12, and a generated excitation signal is output to the amplifier 12.

The amplifier 12 appropriately adjusts and outputs an amplitude value (gain) of an excitation signal input from the FB-NC unit 11. The amplifier 12 is connected to the actuator A, and an excitation signal output from the amplifier 12 is output to the actuator A. With this, vibration for cancellation is excited on the object T to be controlled, thereby canceling the vibration. This FB-NC processing for noise canceling is required to have a real-time characteristic as described above, and hence, high-speed arithmetic processing is performed.

The signal processing circuit C also includes, as components for performing adaptive processing (for example, processing similar to self-tuning described above), two decimation filters 13 and 14, a controller 15, a memory 16, and a communication circuit 17.

The decimation filter 13, which is one of the decimation filters, is connected to the sensor S. The decimation filter 13 converts a sampling frequency (reduces a sampling rate) of sensor information input from the sensor S and outputs the resultant. The decimation filter 14, which is the other decimation filter, is connected to the amplifier 12. The decimation filter 14 converts a sampling frequency (reduces a sampling rate) of an excitation signal output from the amplifier 12 and outputs the resultant. Since adaptive processing is not required to have a real-time characteristic as described above, the sampling rates of the sensor information and the excitation signal that are used for adaptive processing are reduced. The decimation filters 13 and 14 are each connected to the communication circuit 17, and the sensor information and the excitation signal that have sampling frequencies converted by the decimation filters 13 and 14 are each output to the communication circuit 17.

The controller (a control unit of the child apparatus 10) 15 includes, for example, a processor such as a DSP (Digital Signal Processor), an MPU (Micro-Processing Unit), or a CPU (Central Processing Unit). The controller 15 is connected to each component of the child apparatus 10, for example, to control operation of the overall child apparatus 10. Specifically, the controller 15 is connected to the amplifier 12 to control the amplifier 12. Further, the controller 15 is connected to the memory 16 to appropriately write or read data to or from the memory 16. Moreover, the controller 15 is connected to the communication circuit 17 to control the communication circuit 17, thereby controlling communication with the parent apparatus 20.

The controller 15 reads and executes a program stored in the memory 16, for example, to perform various types of processing (for example, transmission mode processing, adjustment mode processing, and the like described later), thereby providing various functions of the child apparatus 10. Note that the program may be stored in another storage apparatus, for example, an external storage such as a USB memory, may be provided via a network, or may be executed in part by another apparatus via a network. The information processing apparatus according to the present disclosure includes one that is provided to the child apparatus 10 and that at least includes the controller 15.

For example, the controller 15 processes data received from the parent apparatus. Specifically, the controller 15 controls the amplifier 12 on the basis of adjustment information (described in detail later) received from the parent apparatus 20. Further, for example, the controller 15 generates data to be transmitted to the parent apparatus 20. Specifically, the controller 15 monitors states of the actuator A and the sensor S of the module and generates a flag in a case where an abnormality occurs. Then, the controller 15 performs control for a module protection function (fail-safe function) based on the transmitted and received contents. For example, the controller 15 compensates for the operation of the module of another child apparatus 10 that is in an abnormal state (including a state regarded as an abnormal state such as a power-off state), by increasing the output of its own actuator A. In a case where an abnormality is detected in its own actuator A or sensor S, the controller 15 decreases the output of the actuator A or turns off the child apparatus 10 to perform protection.

The memory 16 includes a ROM (Read Only Memory) or a RAM (Random Access Memory), for example. The memory 16 stores, for example, a program that is read by the controller 15 to execute each processing process by the child apparatus 10, which is described later, and various types of data that are read by the controller 15 to be used for each processing process. For example, the memory 16 stores information regarding the child apparatus 10 itself (for example, module information described later) and data received from the parent apparatus 20 (for example, adjustment information) through communication.

The communication circuit 17 includes a wireless communication module, for example, and has a function of wirelessly transmitting and receiving a signal to and from the parent apparatus 20. The communication circuit 17 can establish communication by using any communication standard such as cellular communication such as 4G or 5G, a wireless LAN (Local Area Network), Wi-Fi (registered trademark), or Bluetooth (registered trademark). For example, the communication circuit 17 transmits child apparatus information (specifically, sensor information, excitation information, and module information) to the parent apparatus 20 and receives adjustment information.

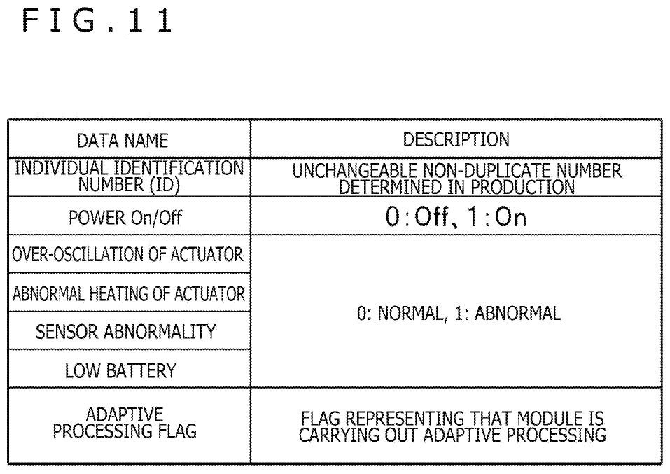

FIG. 11 is a diagram illustrating a configuration example of module information. Module information is information regarding a vibration control module and includes, for example, an individual identification number (ID) of the module, a state flag, and an adaptive processing flag that is used for adaptive processing described later. Module information is stored in the memory 16, for example, and used for the overall optimization of a vibration level in signal processing and fail-safe in an abnormal state. Module information is used as mutual information that is transmitted and received to and from the parent apparatus 20, for example.

An individual identification number is a unique non-duplicate number that is determined in producing a module and unchanged. A state flag is information indicating a state of a vibration control module and is automatically set depending on the state of the module, for example. A state flag includes, for example, “power On/Off” indicating whether the power of a vibration control module is on or off and an abnormality flag indicating whether or not the state of a vibration control module is abnormal (for example, 0: normal and 1: abnormal). An abnormality flag specifically includes “actuator over-oscillation” indicating whether or not the actuator A of a vibration control module is in an over-oscillation state and “actuator abnormal heating” indicating whether or not the actuator A of a vibration control module is in an abnormal heating state. Note that the heating state of the actuator A is detected by using a temperature sensor (not illustrated). Moreover, an abnormality flag includes “sensor abnormality” indicating whether or not the sensor S of a vibration control module is in an abnormal state and “low battery” indicating whether or not the remaining battery of a vibration control module is low. An adaptive processing flag indicates whether or not a vibration control module is carrying out adaptive processing (for example, 0: adaptive processing is not being carried out and 1: adaptive processing is being carried out).

### [Configuration Example of Parent Apparatus]

The parent apparatus 20 includes computer equipment, for example, and includes a parent apparatus-side communication circuit 21, a parent apparatus-side control unit 22, and a parent apparatus-side memory 23. Examples of the parent apparatus 20 include portable terminals such as smartphones and tablets and equipment such as in-vehicle apparatuses, music/video reproduction apparatuses, television apparatuses, and personal computers. That is, the parent apparatus 20 may be an apparatus including a portable casing, such as a portable terminal or a music/video reproduction apparatus. This can lead to an increased degree of freedom of installation. Further, the parent apparatus 20 may be an apparatus including a casing that is installed on a moving body, such as an in-vehicle apparatus. With this, noise in a moving body can be controlled.

The parent apparatus-side communication circuit (a communication circuit of the parent apparatus 20) 21 has a function of wirelessly transmitting and receiving a signal to and from the child apparatus 10. For example, the parent apparatus-side communication circuit 21 can establish communication by using any communication standard such as cellular communication such as 4G or 5G, a wireless LAN, Wi-Fi (registered trademark), or Bluetooth (registered trademark). For example, the parent apparatus-side communication circuit 21 receives child apparatus information and transmits adjustment information.

The parent apparatus-side control unit (a control unit of the parent apparatus 20) 22 includes, for example, a processor such as a DSP, an MPU, or a CPU. The parent apparatus-side control unit 22 is connected to each component of the parent apparatus 20, for example, to control operation of the overall parent apparatus 20. For example, the parent apparatus-side control unit 22 is connected to the parent apparatus-side communication circuit 21 to control the parent apparatus-side communication circuit 21, thereby controlling communication with the child apparatus 10. Further, the parent apparatus-side control unit 22 is connected to the parent apparatus-side memory 23 to appropriately write or read data to or from the parent apparatus-side memory 23.

The parent apparatus-side control unit 22 reads and executes a program stored in the parent apparatus-side memory 23, for example, to perform various types of processing (specifically, adaptive processing with an adaptive algorithm described later and the like), thereby providing various functions of the parent apparatus 20. Note that the program may be stored in another storage apparatus, for example, an external storage such as a USB memory, may be provided via a network, or may be executed in part by another apparatus via a network. The information processing apparatus according to the present disclosure includes one that is provided to the parent apparatus 20 and that at least includes the parent apparatus-side control unit 22.

The parent apparatus-side memory (a memory of the parent apparatus 20) 23 includes a RAM, a ROM, or the like and stores, for example, a program that is read by the parent apparatus-side control unit 22 to execute each processing process by the parent apparatus 20, which is described later, and various types of data that are read by the parent apparatus-side control unit 22 to be used for each processing process. In the parent apparatus-side memory 23 of the parent apparatus 20, for example, non-real-time information transmitted from each of the child apparatuses 10 is aggregated.

### [Exemplary Overall Processing]

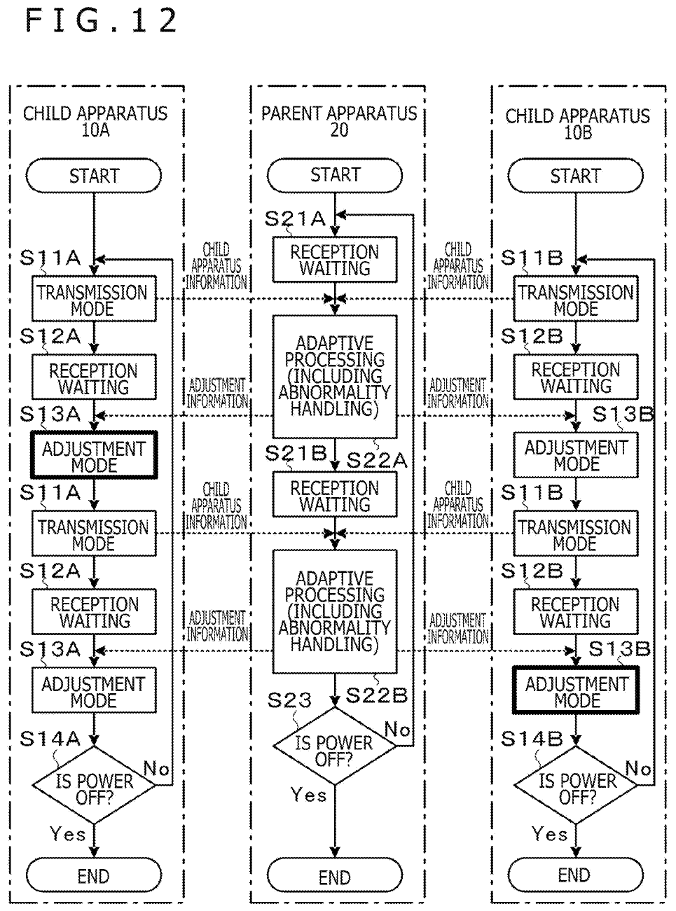

FIG. 12 is a sequence diagram illustrating an exemplary flow of overall processing in the noise control system 1. Note that the order of processing processes (steps) described below can be changed as long as each processing process is not hindered. The processing by the child apparatuses 10A and 10B and the parent apparatus 20 starts when the child apparatuses 10A and 10B and the parent apparatus 20 are each turned on, for example. For example, the processing operation of the child apparatus 10A or 10B is controlled by the controller 15 thereof, and the processing operation of the parent apparatus 20 is controlled by the parent apparatus-side control unit 22. However, noise canceling processing by the child apparatus 10A or 10B, which is required to have a real-time characteristic, is separately performed at a high speed by the FB-NC unit 11.

The parent apparatus 20 first enters a reception waiting state when the processing starts (Step S21A). Meanwhile, the child apparatus 10A or 10B first performs transmission mode processing when the processing starts (Step S11A or S11B). As described in detail later, in transmission mode processing, specifically, the child apparatus 10A or 10B prepares to wirelessly transmit module information (that is, child apparatus information) in addition to decimated sensor information or the like to the parent apparatus 20 and transmits the information by the communication circuit 17 (see FIG. 10) after the preparation. After transmitting the child apparatus information, the child apparatus 10A or 10B enters a reception waiting state (Step S12A or S12B).

After receiving the child apparatus information from each of the child apparatuses 10A and 10B, the parent apparatus 20 performs adaptive processing (Step S22A). As described in detail later, in adaptive processing, specifically, the parent apparatus 20 performs a calculation to optimize the overall system by using the child apparatus information received from each of the child apparatuses 10A and 10B and transmits information regarding the processing result (adjustment information) to the child apparatuses 10A and 10B. For example, optimization by adaptive processing is performed sequentially on the child apparatuses 10A and 10B with use of an adaptive processing flag or the like. With this, for example, even in a case where adaptive processing performs tuning similar to self-tuning described above with the restriction described above, processing under the restriction can efficiently be performed. In the example illustrated, the child apparatus 10A and the child apparatus 10B are subjected to adaptive processing in this order. The parent apparatus 20 enters the reception waiting state again after the adaptive processing in Step S22A (Step S21B).

In the case where the child apparatus 10A or 10B receives the adjustment information from the parent apparatus 20 in the reception waiting state in Step S12A or S12B, the child apparatus 10A or 10B performs adjustment mode processing (Step S13A or S13B). As described in detail later, in adjustment mode processing, specifically, the child apparatus 10A or 10B changes the amplitude value (gain) of an excitation signal on the basis of the adjustment information received from the parent apparatus 20 in a case where the child apparatus 10A or 10B is a module to be adjusted. For example, a higher gain implements a higher contribution rate for the overall control of a module, whereas a lower gain leads to fail-safe. This gain adjustment by adjustment mode processing is performed sequentially on the child apparatuses 10A and 10B. In the example illustrated, as indicated by thick frames, the child apparatus 10A and the child apparatus 10B are subjected to adjustment mode processing in this order. With this, even in a case with the restriction described above, processing under the restriction can be performed. Note that, when there is no such restriction described above, this gain adjustment by adjustment mode processing and optimization by adaptive processing described above are not necessarily required to be performed sequentially on the child apparatuses 10A and 10B.

After the adjustment mode processing in Step S13A or S13B, the child apparatus 10A or 10B repeats the processing from Step S11A or S11B to Step S13A or 13B after the elapse of a waiting time for the next transmission. When the gains of all the child apparatuses 10 (the child apparatus 10B in the example illustrated) are adjusted, a series of gain adjustment processes are finished. Accordingly, the parent apparatus 20 receives, in the reception waiting state in Step S21B, the child apparatus information from the child apparatuses 10A and 10B. The parent apparatus 20 performs adaptive processing again and transmits adjustment information to the child apparatuses 10A and 10B (Step S22B).

Then, the child apparatus 10A or 10B determines whether or not its own power is off (Step S14A or S14B). Then, in a case where it is determined in Step S14A or S14B that the power is not off (No), the child apparatus 10A or 10B returns the processing to Step S11A or S11B. Meanwhile, in a case where it is determined in Step S14A or S14B that the power is off (Yes), the child apparatus 10A or 10B ends the processing.

The parent apparatus 20 also determines whether or not its own power is off (Step S23) and returns the processing to Step S21A in a case where it is determined that the power is not off (No). Meanwhile, in a case where it is determined in Step S23 that the power is off (Yes), the parent apparatus 20 ends the processing.

### [Transmission Mode Processing in Child Apparatus]

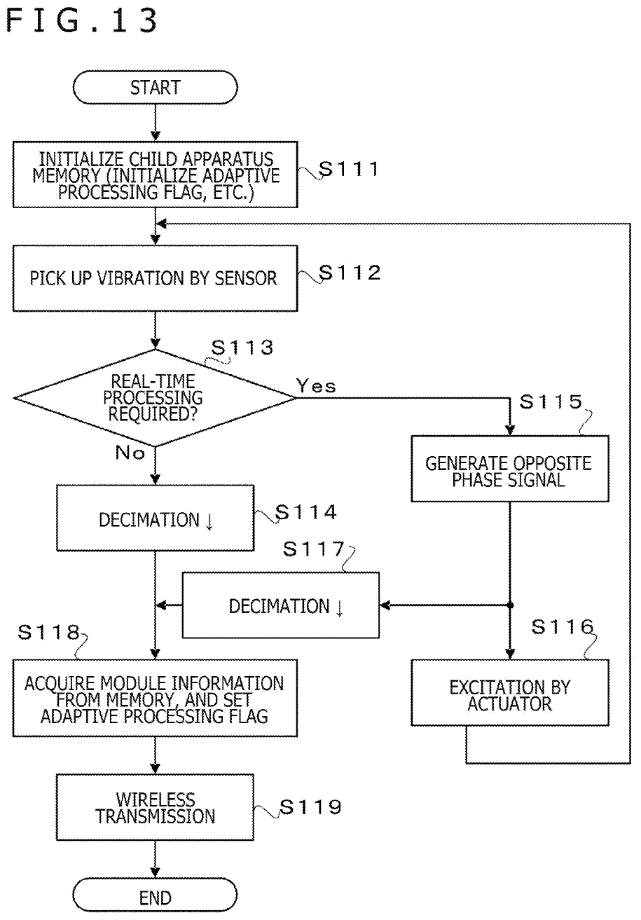

Here, transmission mode processing in the child apparatuses 10A and 10B described above is described in detail. FIG. 13 is a flowchart illustrating an exemplary flow of transmission mode processing. When transmission mode processing starts, the child apparatus 10A or 10B initializes information stored in its own memory 16 (specifically, an adaptive processing flag or the like) (Step S111).

The child apparatus 10A or 10B determines, when the sensor S picks up or detects vibration after the initialization processing in Step S111 (Step S112), the necessity of real-time processing in response to the detection (Step S113). Here, as described above, noise canceling processing is required to have a real-time characteristic. Meanwhile, a signal that is used for adaptive processing is not required to have a real-time characteristic. Hence, the child apparatus 10A or 10B determines in Step S113 that real-time processing is required (Yes) in a case where noise canceling processing is to be performed and determines in Step S113 that real-time processing is not required (No) in a case where there is a signal that is used for adaptive processing.

In a case where it is determined in Step S113 that a real-time characteristic is not required (No), the child apparatus 10A or 10B decimates the sensor signal by using the decimation filter 13 (Step S114). Meanwhile, in a case where it is determined in Step S113 that a real-time characteristic is required (Yes), the child apparatus 10A or 10B generates an excitation signal (opposite phase signal) by using the FB-NC unit 11 and the amplifier 12 (Step S115). Then, the child apparatus 10A or 10B drives the actuator A with the generated excitation signal to add vibration to the object T to be controlled (Step S116). On this occasion, the child apparatus 10A or 10B decimates, by using the decimation filter 14, the excitation signal generated in Step S115 (Step S117). After driving the actuator A in Step S116, the child apparatus 10A or 10B returns the processing to Step S112.

After the processing in Step S114 and Step S117, the child apparatus 10A or 10B reads and acquires its own unique module information from the memory 16 and sets an adaptive processing flag (Step S118). For example, in a case where the adaptive processing of the child apparatus 10A is to be performed, the child apparatus 10A is set to be processed, and the child apparatus 10B, which is the other child apparatus, is set not to be processed. Then, the child apparatus 10A or 10B wirelessly transmits, by using the communication circuit 17, the sensor information decimated in Step S114, the excitation signal decimated in Step S117, and the module information acquired in Step S118 to the parent apparatus 20 as child apparatus information (Step S119) and ends the processing.

### [Adjustment Mode Processing in Child Apparatus]

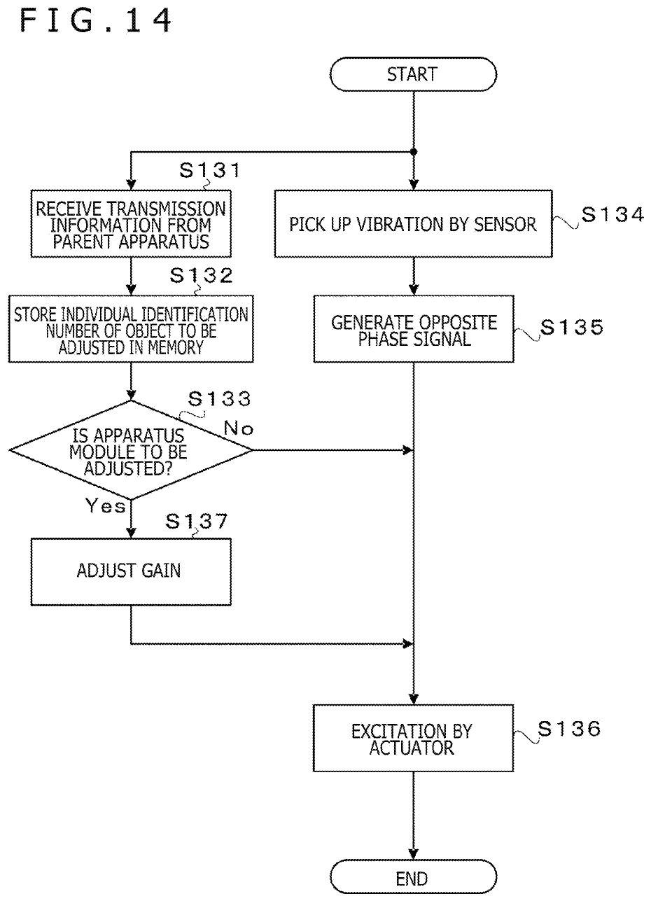

Next, adjustment mode processing in the child apparatuses 10A and 10B described above is described in detail. FIG. 14 is a flowchart illustrating an exemplary flow of adjustment mode processing. When adjustment mode processing starts, the child apparatus 10A or 10B receives, by the communication circuit 17, transmission information (adjustment information) transmitted from the parent apparatus 20 (Step S131). Next, the child apparatus 10A or 10B stores the individual identification number of a module to be adjusted included in the adjustment information in the memory 16 (Step S132). Then, the child apparatus 10A or 10B determines whether or not the child apparatus 10A or 10B itself is a module to be adjusted (Step S133). Specifically, the child apparatus 10A or 10B determines whether or not its own individual identification number and the individual identification number of a module to be adjusted received from the parent apparatus 20 are identical to each other. The child apparatus 10A or 10B determines that the child apparatus 10A or 10B itself is a module to be adjusted in a case where the individual identification numbers are identical to each other and determines that the child apparatus 10A or 10B itself is not a module to be adjusted in a case where the individual identification numbers are not identical to each other.

Here, also in adjustment mode processing, the child apparatus 10A or 10B generates, when the sensor S picks up vibration (Step S134), an excitation signal (opposite phase signal) by using the FB-NC unit 11 and the amplifier 12 (step S135).

In a case where it is determined in Step S133 that the child apparatus 10A or 10B itself is not a module to be adjusted (No), the child apparatus 10A or 10B performs, without adjusting the gain of the opposite phase signal generated in Step S135, excitation by the actuator A (Step S136) and ends the processing. On the other hand, in a case where it is determined in Step S133 that the child apparatus 10A or 10B itself is a module to be adjusted (Yes), the child apparatus 10A or 10B adjusts the gain of the opposite phase signal generated in Step S135 (Step S137), performs excitation by the actuator A with the adjusted signal (Step S136), and ends the processing. For example, in a case where tuning similar to self-tuning described above is to be performed as adaptive processing, since the number of modules allowed to execute tuning processing at the same time is limited to one, it is only necessary to adjust the gain of a tuning module.

### [Adaptive Processing in Parent Apparatus]

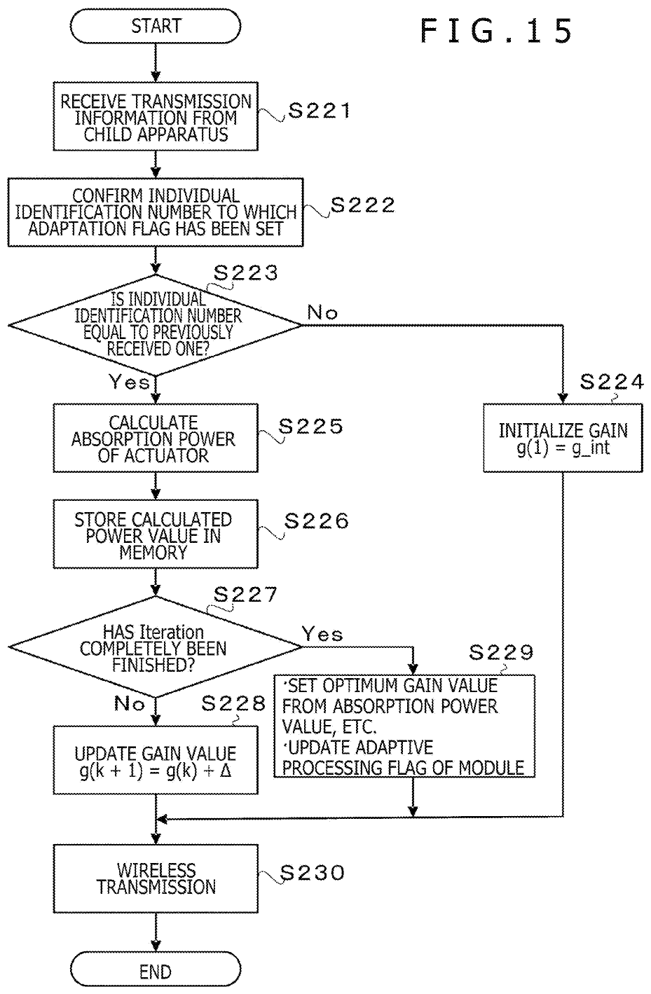

Next, adaptive processing in the parent apparatus 20 described above is described in detail. FIG. 15 is a flowchart illustrating an exemplary flow of adaptive processing. When adaptive processing starts, the parent apparatus 20 receives, by the parent apparatus-side communication circuit 21, transmission information (child apparatus information) transmitted from the child apparatus 10 (Step S221). Next, the parent apparatus 20 confirms an individual identification number to which an adaptive processing flag has been set (which has been set to be subjected to adaptive processing) (Step S222). Then, the parent apparatus 20 determines whether or not the individual identification number is equal to an individual identification number confirmed in the last reception (Step S223). The fact that an individual identification number is equal to an individual identification number confirmed in the last reception means that an optimum value is being searched for with different gains in the same module. Further, the fact that an individual identification number is not equal to an individual identification number confirmed in the last reception means that the optimization (adjustment) of the last module has been completed and the processing has proceeded to the optimization processing of the next module.

In a case where it is determined in Step S223 that the individual identification number is not equal to the individual identification number confirmed in the last reception (No), the parent apparatus 20 initializes the gain (g) (for example, “g(1)=g_int”) (Step S224). In a case where it is determined in Step S223 that the individual identification number is equal to the individual identification number confirmed in the last reception (Yes), the parent apparatus 20 calculates an absorption power of the actuator A (Step S225) and stores the calculated power value in the memory 16 (Step S226). For example, the absorption power can be obtained with the self-tuning algorithm described above.

Then, the parent apparatus 20 determines whether an iteration has completely been finished (Step S227). In a case where it is determined in Step S227 that the iteration has not completely been finished (No), the parent apparatus 20 updates the gain (g) (for example, “g(k+1)=g(k)+A (k: iteration number)”) (Step S228). The fact that an iteration is finished completely means that, for example, the processing is sequentially performed with a gain changed by A from an initial value to a limit value and finished. Meanwhile, in a case where it is determined that the iteration has completely been finished (Yes), the parent apparatus 20 sets the optimum gain (g) from the absorption power value and updates the adaptive processing flag of the module (Step S229). The optimum value of the gain of each of the child apparatuses 10 is determined by performing the processing of changing a gain by multiple times (a predetermined number of times) in this way.

Note that a gain is set to an optimum value with reference not only to an absorption power value but also to a state flag transmitted from the child apparatus 10. Specifically, the parent apparatus 20 detects, from a state flag received from the child apparatus 10, whether there exists the child apparatus 10 in an abnormal state (in which the gain of the child apparatus 10 in question or another child apparatus is to preferably be adjusted). In the case where the parent apparatus 20 detects the abnormal child apparatus 10, the parent apparatus 20 appropriately adjusts the gain value of an excitation signal for the child apparatus 10 in question or another child apparatus 10 depending on the state, thereby setting the gain value to an optimum value. For example, in a case where the actuator A is in an over-oscillation state or an abnormal heating state, in a case where the sensor S is in an abnormal state, or in a case where the remaining battery is low, the parent apparatus 20 appropriately decreases the gain of an excitation signal for the child apparatus 10 or turns off the child apparatus 10, to thereby protect the system. Meanwhile, in a case where it is determined that there exists the child apparatus 10 in such a state, the parent apparatus 20 appropriately increases the gain of an excitation signal for another child apparatus 10 to compensate for the operation of the child apparatus 10 in such a state. In a case where there exists the child apparatus 10 in the power-off state, the parent apparatus 20 may appropriately increase the gain of an excitation signal for another child apparatus 10. Those can lead to an enhanced system fail-safe function.

After the processing in Step S224, Step S228, or Step S229, the parent apparatus 20 wirelessly transmits, by the parent apparatus-side communication circuit 21, information regarding the set gain to the child apparatus 10 together with the individual identification number to which an adaptive processing flag has been set, as adjustment information (Step S230), and ends the processing.

In this way, in the noise control system 1, the adaptive processing of each of the child apparatuses 10 can collectively be performed in the parent apparatus 20, so that a load to be applied to the child apparatus 10 can be reduced to prevent an increase in size of the child apparatus 10. Adaptive processing is performed by aggregating pieces of child apparatus information regarding the child apparatuses 10A and 10B, so that better optimization can be implemented.

### [Another Exemplary Overall Processing]

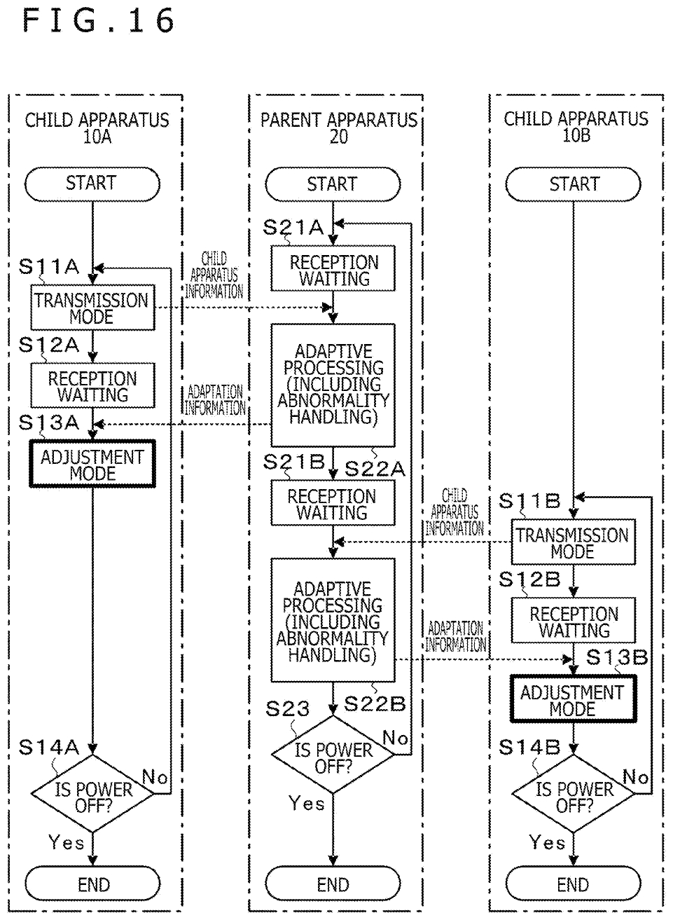

Here, the overall processing illustrated in FIG. 12 may be processing as described below. FIG. 16 is a sequence diagram illustrating another exemplary flow of the overall processing in the noise control system 1. In the example of FIG. 12, child apparatus information is transmitted from all the child apparatuses 10 (child apparatuses 10A and 10B) to the parent apparatus 20 in transmission mode processing, and adjustment information is transmitted from the parent apparatus 20 to all the child apparatuses 10 (child apparatuses 10A and 10B) in adaptive processing. In the example illustrated in FIG. 16, only the child apparatus 10 that is to perform adaptive processing transmits child apparatus information to the parent apparatus 20 in transmission mode processing, and the parent apparatus 20 transmits, in adaptive processing, adjustment information to only the child apparatus 10 that is to adjust the gain. Note that child apparatus information regarding each of the child apparatuses 10 may be aggregated in the parent apparatus 20.

That is, first, only the child apparatus 10A sequentially performs transmission mode processing (Step S11A) and reception waiting (Step S12A). The parent apparatus 20 receives, in the reception waiting state (Step S21A), the child apparatus information transmitted from the child apparatus 10A, performs adaptive processing, and transmits adjustment information to the child apparatus 10A (Step S22A). Then, the parent apparatus 20 enters the reception waiting state again (Step S21B). The child apparatus 10A receives, in the reception waiting state (Step S12A), the adjustment information transmitted from the parent apparatus 20, performs adjustment mode processing (Step S13A), and then determines whether or not the power is off (Step S14A). The child apparatus 10A returns the processing to Step S11A when the power is not off, and ends the processing when the power is off.

Then, after the child apparatus 10A has finished adjustment mode processing, this time, only the child apparatus 10B sequentially performs transmission mode processing (Step S11B) and reception waiting (Step S12B). The parent apparatus 20 receives, in the reception waiting state for the second time (Step S21B), the child apparatus information transmitted from the child apparatus 10B, performs adaptive processing, and transmits adjustment information to the child apparatus 10B (Step S22B). Then, the parent apparatus 20 determines whether or not the power is off (Step S23). The parent apparatus 20 returns the processing to Step S21A when the power is not off, and ends the processing when the power is off.

The child apparatus 10B receives, in the reception waiting state (Step S12B), the adjustment information transmitted from the parent apparatus 20, performs adjustment mode processing (Step S13B), and then determines whether or not the power is off (Step S14B). The child apparatus 10B returns the processing to Step S11B when the power is not off, and ends the processing when the power is off.

Note that the details of each processing process are basically as described above, and hence, the detailed description thereof is omitted here. In this way, all the processing processes may be sequentially performed in vibration control module units. This can lead to a reduced system processing load.

As described above, in the noise control system 1, FB-NC processing for noise canceling requires high-speed arithmetic processing. Meanwhile, adaptive processing such as self-tuning is not required to have a real-time characteristic. Hence, in the noise control system 1, information that is used for processing not required to have a real-time characteristic (specifically, sensor information and excitation information that are used for adaptive processing) is decimated, in other words, lowered in sampling rate (specifically, subjected to a sampling frequency conversion by the decimation filter 13 or 14), and the data is wirelessly transmitted to the parent apparatus 20 to be processed in the parent apparatus 20. In this way, in the noise control system 1, FB-NC processing is performed at a high speed, and adaptive processing is performed at a speed lower than that of FB-NC processing. With this, the child apparatus 10 configured to perform high-speed processing can be separated into a high-speed unit and a low-speed unit lower in speed than the high-speed unit, and various types of wireless communication can be supported by the low-speed unit, for example.

In this way, in the multiple child apparatuses 10 (child apparatuses 10A and 10B), which are noise canceling apparatuses based on vibration control, while decentralized control-based control is performed, the block not required to have a real-time characteristic (specifically, adaptive processing block) is separated from the child apparatuses 10 by the communication circuit 17, and child apparatus information regarding each of the child apparatuses 10 lowered in sampling rate is shared with the parent apparatus 20, with the result that overall optimization can be implemented with use of wirelessly managed mutual information while the degree of freedom of wiring, which is the advantage of decentralized control, is maintained. This can lead to enhanced system transparency, an enhanced degree of freedom of module placement, and a noise canceling effect enhanced from that of a related-art decentralized control system.

Further, since mutual module information regarding the multiple child apparatuses 10 can be shared with the parent apparatus 20, even in a case where an abnormality occurs in a certain module, divergence of the overall system can be prevented by decreasing the drive gain of another module, for example. Further, the operation of an abnormal module can be compensated for by increasing the drive gain of another module, for example. With this, even when fail-safe due to abnormal excitation by the actuator A, fail-safe due to a failure of the sensor S, or a failure of the sensor S or the actuator A occurs, for example, overall optimization can be performed again.

### 2. Second Embodiment

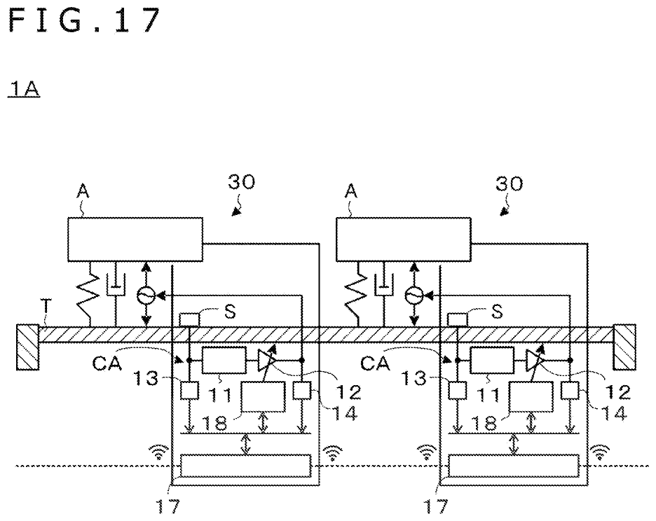

FIG. 17 illustrates a configuration example of a noise control system according to a second embodiment (noise control system 1A). The noise control system 1A according to the present embodiment is different from the first embodiment in that a noise canceling apparatus 30 corresponding to the child apparatus 10 of the first embodiment has the function of the parent apparatus 20 of the first embodiment, and that the noise canceling apparatuses 30 (for example, the noise canceling apparatuses 30 close to each other) are connected to each other in a row (daisy chain connection). Other points are basically similar to those of the first embodiment described above, and hence, the detailed description thereof is omitted here.

The noise control system 1A includes the multiple noise canceling apparatuses 30. The noise canceling apparatus 30 includes the sensor S, the actuator A, and a signal processing circuit CA. The signal processing circuit CA includes the FB-NC unit 11 and the amplifier 12 that perform FB-NC processing together with the sensor S and the actuator A. Further, the signal processing circuit CA includes the decimation filters 13 and 14, the communication circuit 17, and an adaptive processing unit 18. The signal processing circuit CA is different from the signal processing circuit C of the first embodiment in that the adaptive processing unit 18 is included instead of the controller 15 and the memory 16 of the first embodiment, and that the decimation filters 13 and 14, the communication circuit 17, and the adaptive processing unit 18 are connected to each other through a data bus.

The communication circuit 17 includes a wireless communication module, for example, and has a function of wirelessly transmitting and receiving a signal to and from another noise canceling apparatus 30. For example, the communication circuit 17 transmits its own child apparatus information (for example, module information or the like) to another noise canceling apparatus 30 and receives child apparatus information regarding another noise canceling apparatus 30. In this way, the noise control system 1A employs a form in which information (specifically, module information regarding each of the noise canceling apparatus 30) is mutually shared between the noise canceling apparatuses 30.

The adaptive processing unit 18 includes a circuit for adaptive processing (specifically, a processor similar to the controller 15, a memory similar to the memory 16, and the like), for example. That is, the noise canceling apparatuses 30 each carry out adaptive processing described above in its own module. The adaptive processing unit 18 has, for example, in addition to the functions of the controller 15 and the memory 16 of the first embodiment described above, the functions of the parent apparatus-side control unit 22 and the parent apparatus-side memory 23 of the parent apparatus 20 of the first embodiment. That is, the adaptive processing unit 18 executes both processing by the child apparatus 10 and processing by the parent apparatus 20 of the first embodiment described above.

With this, while decentralized control-based control is performed, the block not required to have a real-time characteristic (specifically, adaptive processing block) can be separated from the block configured to perform FB-NC processing, and adaptive processing can be performed at a lowered sampling rate. Hence, as in the first embodiment described above, overall optimization can be implemented by using wirelessly managed mutual information while the degree of freedom of wiring, which is the advantage of decentralized control, is maintained. This results in enhanced system transparency, an enhanced degree of freedom of module placement, and a noise canceling effect enhanced from that of a related-art decentralized control system. Further, a huge module configured to organize information such as child apparatus information (the parent apparatus 20 of the first embodiment) is not required, so that the system configuration can be simplified.

### 3. Third Embodiment

In the first embodiment and second embodiment described above, the control “vibration sensor—vibration control” is performed in order to cut off a propagation source of a noise source. Meanwhile, as already illustrated in FIG. 1, control may be performed after acoustic emission, by using a sound output apparatus (for example, a speaker) for noise canceling with information from a vibration sensor. This corresponds to “vibration sensor—sound control” of FIG. 1.

Here, as is generally known, as active noise canceling apparatuses, there are two types of systems, i.e., a feedforward system and a feedback system. Now, block diagrams of the systems are briefly described.

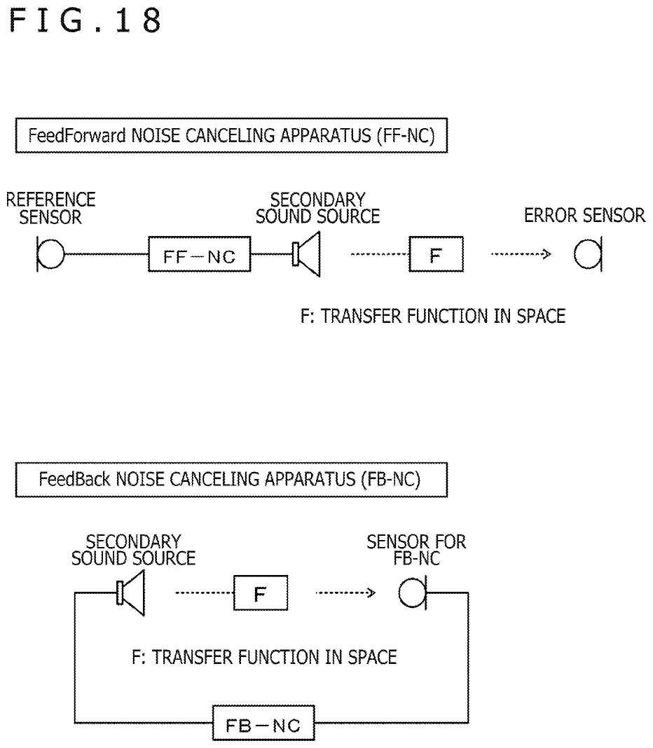

FIG. 18 is an explanatory diagram illustrating feedforward and feedback noise canceling. As illustrated in FIG. 18, a feedforward noise canceling apparatus (FF-NC system) reduces noise with a reference sensor placed at a position that has a high correlation with a noise source and that can guarantee causality until emission of a cancellation signal from a secondary sound source. Meanwhile, a feedback noise canceling apparatus (FB-NC system) reduces noise by directly feeding back a signal from a sensor placed in a space to be controlled.

As can be found from the above, in the case of an FB-NC system, a delay of the system directly results in performance degradation. In the case of an FF-NC system, however, there is a margin corresponding to a space propagation time of noise, so that a delay can be allowed in some cases. Thus, in a third embodiment, sensor information output from the sensor S is applied to a feedforward noise canceling apparatus (FF-NC system) by using the module of the noise control system 1 of the first embodiment described above.

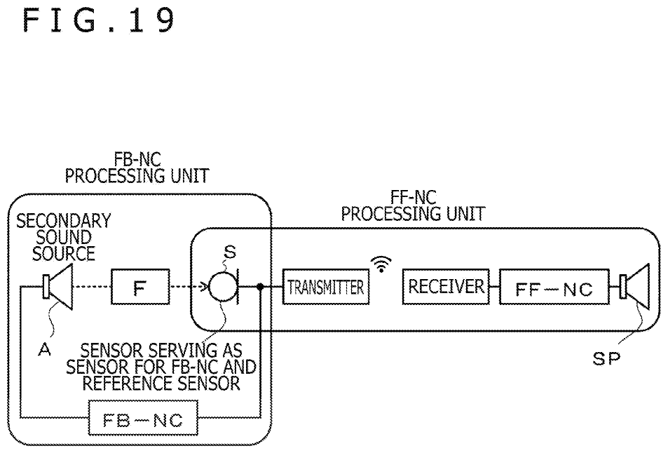

FIG. 19 is a diagram illustrating a configuration example of a signal processing block according to the present embodiment. An FB-NC processing unit of FIG. 19 indicates a single module configured to perform decentralized control described in the first embodiment, namely, a vibration control module. Here, the sensor S of the module is used as a sensor for feedback (sensor for FB-NC) in terms of “vibration sensor—vibration control” and can also be used for another purpose, specifically, used as a reference sensor in the FF-NC system, since acoustic emission noise from an object to be controlled has a high correlation with the vibration of the object.

This is because, while sensor information from each module cannot be shared in “vibration sensor—vibration control” since a delay cannot be allowed, in the FF-NC system, a processing delay corresponding to a space propagation delay can be allowed as described above, so that the sensor S can be used as a sensor for FF-NC signal processing for “vibration sensor—sound control.” Thus, in the present embodiment, the sensor S is also used as a sensor (reference sensor) for FF-NC signal processing.

Specifically, in an FF-NC processing unit, sensor information from the sensor S is wirelessly transmitted by a transmitter. Then, the sensor information is received by a receiver, FF-NC processing is performed to generate a cancellation signal, and sound for cancellation (specifically, sound having an opposite phase signal) is output from a sound output apparatus SP such as a speaker, to thereby reduce noise. Note that FF-NC processing can employ a known technology, and hence, the detailed description thereof is herein omitted.

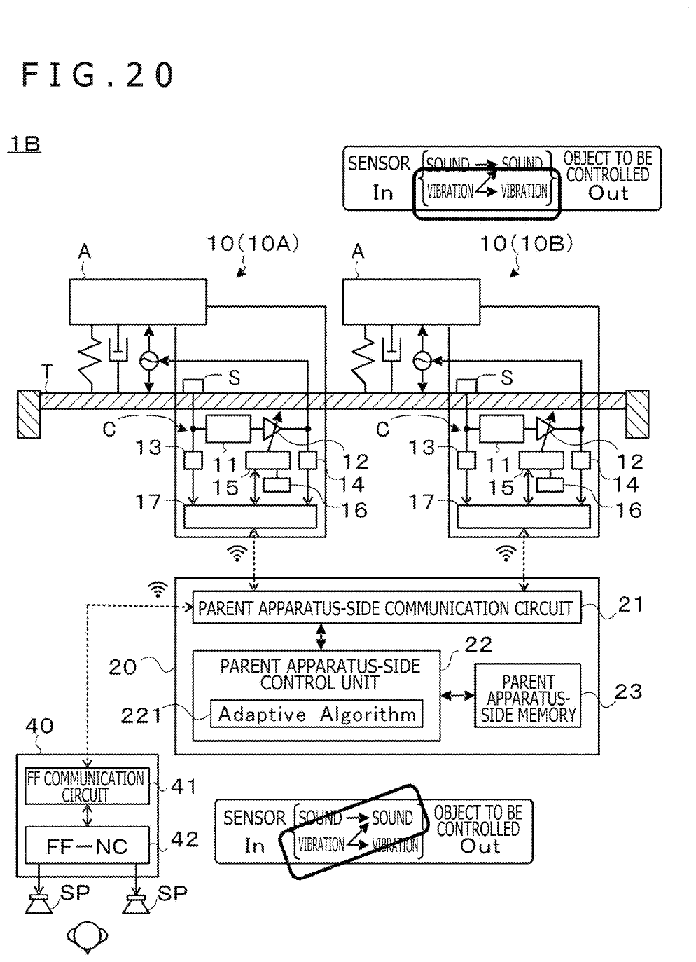

FIG. 20 illustrates a configuration example of a noise control system according to the present embodiment (noise control system 1B). The noise control system 1B according to the present embodiment is different from the noise control system 1 according to the first embodiment in including an FF-NC apparatus 40. Other points are basically similar to those of the first embodiment described above. As described above, the parent apparatus 20 receives child apparatus information including sensor information regarding each of the child apparatuses 10. In the noise control system 1B, sensor information regarding each of the child apparatuses 10 is relayed by the parent apparatus 20 to be used for FF-NC processing in the FF-NC apparatus 40.

That is, the parent apparatus 20 of the present embodiment has two roles (functions). One of the roles is to centrally manage mutual information regarding the decentralized control module (each of the child apparatuses 10) mounted on the object T to be controlled and carry out the overall optimization of the vibration level. The other is to centrally manage sensor information regarding the decentralized control module and operate as a relay configured to transmit the sensor information to the FF-NC apparatus 40 as reference sensor information for FF-NC. That is, the parent apparatus-side communication circuit 21 of the parent apparatus 20 also functions as a transmitter configured to transmit sensor information to the FF-NC apparatus 40.

The FF-NC apparatus 40 is an apparatus configured to perform FF-NC processing and includes an FF communication circuit 41, an FF-NC unit 42, and sound output apparatuses SP, for example. The FF communication circuit 41 has a function of wirelessly transmitting and receiving a signal to and from the parent apparatus 20. For example, the FF communication circuit 41 can establish communication by using any communication standard such as cellular communication such as 4G or 5G, a wireless LAN, Wi-Fi (registered trademark), or Bluetooth (registered trademark). The FF communication circuit 41 functions as a receiver configured to receive sensor information from the parent apparatus 20.

The FF communication circuit 41 is connected to the FF-NC unit 42, and sensor information received by the FF communication circuit 41 as mutual information is output to the FF-NC unit 42. The FF-NC unit 42 performs feedforward FF-NC processing. A known technique is applicable to the FF-NC processing. The FF-NC unit 42 includes a noise control filter, an adaptive filter, and an error sensor, for example, and generates a cancellation signal optimized with use of sensor information regarding each module. Note that the FF-NC unit 42 may include, instead of the adaptive filter, a fixed filter with fixed filter coefficients. The FF-NC unit 42 is connected to the sound output apparatuses SP, a generated cancellation signal is output to the sound output apparatuses SP, and sound for cancellation is thus output from the sound output apparatuses SP.

In this way, in the noise control system 1B, sensor information from the sensor S in the noise control module is also used for another purpose, specifically, used as the reference sensor for the FF-NC system, so that “vibration sensor—vibration control” for cutting off a noise source and “vibration sensor—sound control” targeted for acoustic emission noise can simultaneously be achieved. Thus, a higher-performance noise canceling apparatus can be achieved. That is, vibration can be canceled, and sound caused by the remaining vibration can be canceled. Since the sensor S that is used for vibration control is also used as the reference sensor for FF-NC processing, a simplified system configuration can be implemented.

### 4. Fourth Embodiment

In the third embodiment described above, the noise control system 1B that reduces noise and includes, in addition to the noise control system 1 of the first embodiment, the FF-NC apparatus 40 is described. Here, in sharing sensor information regarding the decentralized control module, as described in the second embodiment, the sensor information may be shared, with the FF-NC apparatus 40 of the third embodiment included on a daisy-chain network, without using the parent apparatus 20 of the first embodiment. Hence, in a fourth embodiment, the FF-NC apparatus 40 is added to the daisy-chain network of the noise control system 1A of the second embodiment to implement high-performance noise canceling.

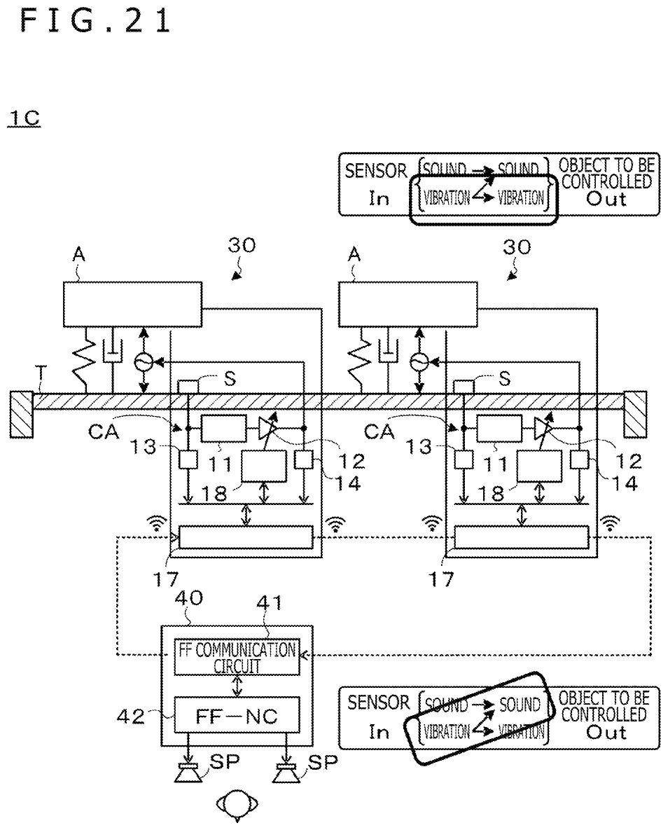

FIG. 21 illustrates a configuration example of a noise control system according to the present embodiment (noise control system 1C). The noise control system 1C according to the present embodiment is different from the noise control system 1A according to the second embodiment in including the FF-NC apparatus 40. Other points are basically similar to those of the second embodiment described above. The FF-NC apparatus 40 is provided on a network connecting the child apparatuses 10 to each other in a row. Each module wirelessly shares its own sensor information through a data bus, and the FF-NC apparatus 40 ultimately executes “vibration sensor—sound control” using the sensor information.

With this, actions and effects similar to those of the noise control system 1B according to the third embodiment are obtained, and a huge module configured to organize such information as child apparatus information (the parent apparatus 20 of the third embodiment) is not required, so that a system configuration simplified more than that of the noise control system 1B can be implemented.

### 5. Fifth Embodiment

Here, the actuator can be mounted on a panel, to be used as a device for reproducing sound such as music (or sound with images such as video). The noise control system 1 according to the first embodiment described above includes the actuator A and the sensor S and is used with the vibration control module installed on the object T to be controlled to control the vibration of the object T to be controlled. The very nature of the noise control system 1 allows the noise control system 1 to reproduce sound by actively exciting the object T to be controlled with a sound signal (for example, music signal for reproduction), in addition to controlling unnecessary vibration. Hence, in the present embodiment, the module mounted for signal control is also used for sound reproduction.

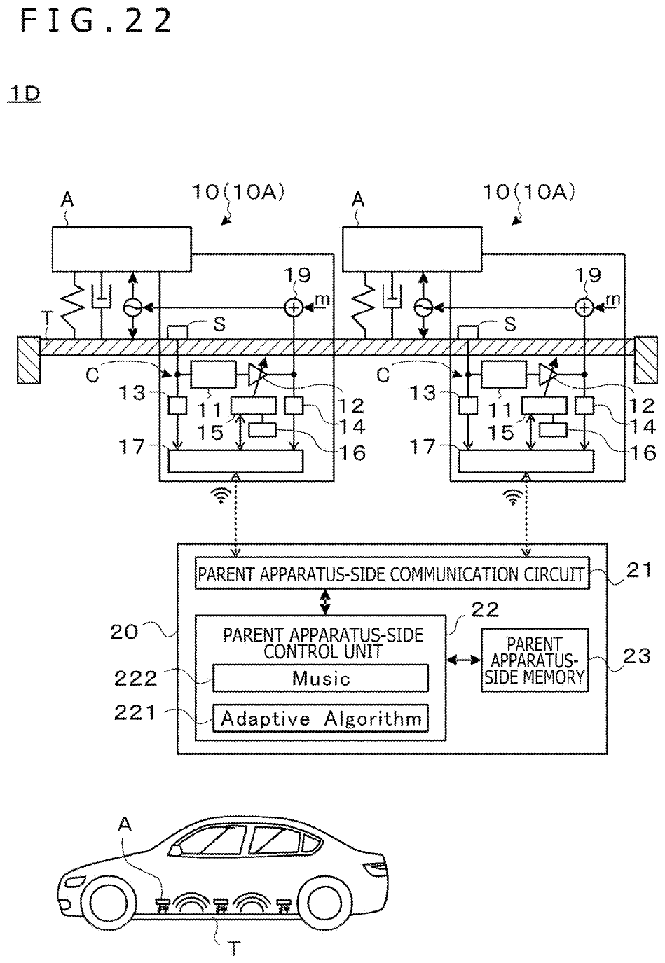

FIG. 22 illustrates a configuration example of a noise control system according to the present embodiment (noise control system 1D). The noise control system 1D includes the multiple child apparatuses 10 and the parent apparatus 20. The parent apparatus 20 includes the parent apparatus-side communication circuit 21, the parent apparatus-side control unit 22, and the parent apparatus-side memory 23. The parent apparatus-side control unit 22 includes an adaptive processing block 221 configured to perform adaptive processing with an adaptive algorithm and a sound reproduction block 222. The parent apparatus-side memory 23 has sound data stored therein.

The sound reproduction block 222 reads and acquires sound data from the parent apparatus-side memory 23 and generates a sound signal m that the actuator A reproduces. The generated sound signal m is appropriately transmitted to each module to be added to an excitation signal for the actuator A by an adder 19 of the child apparatus 10, and the resultant is output. Note that sound data stored in an external storage such as a USB memory may be read and acquired, or sound data may be acquired via a network. The sound signals m for the respective modules may be different from each other.

For example, as illustrated in a lower part of FIG. 22, a panel of a passenger car is regarded as the object T to be controlled, and the child apparatus 10 including the actuator A is installed on the panel of the passenger car. With this, noise generated due to vibration with a road surface, which is called road noise, is reduced by utilizing the module installed on the panel. Meanwhile, stereophonic sound can be reproduced by reproducing a sound signal by the actuator A. For example, the parent apparatus 20 may also be placed in the passenger car. The parent apparatus 20 can be, for example, an in-vehicle apparatus such as a car stereo system or a car navigation system. Note that, in FIG. 22, the actuator A is installed on a floor panel of the passenger car, but the module may be mounted on any in-car place such as a window glass or a door pillar. Further, the module may be applied to a moving body other than a passenger car, such as a vehicle.

In this way, in the noise control system 1D, the actuator A mounted on the module can be used not only as a vibration control device but also as a music reproduction device, so that a novel music listening experience can be achieved.

### 7. Modified Example

While the embodiments of the present disclosure have specifically been described above, the present disclosure is not limited to the embodiments described above, and various modifications based on the technical ideas of the present disclosure are possible. For example, various modifications as described below are possible. Further, any selected one or a plurality of the modified forms described below can be combined as appropriate. Further, the configurations, methods, steps, shapes, materials, numerical values, and the like of the embodiments described above can be combined with each other or separated from each other without departing from the gist of the present disclosure.

For example, connection portions between the respective components of each embodiment or the like described above may be wired connection or wireless connection as long as it is applicable. Specifically, the communication for mutual information sharing between the child apparatus 10 and the parent apparatus 20, between the parent apparatus 20 and the FF-NC apparatus 40, between the noise canceling apparatuses 30, or between the noise canceling apparatus 30 and the FF-NC apparatus 40 may be wired communication instead of wireless communication.

Note that the present disclosure can also employ the following configurations.

(1) An information processing apparatus including:

a control unit configured to control a gain of a drive signal for an actuator that is used for vibration control of an object to be controlled, according to a processing result of adaptive processing using an output signal from a sensor and the drive signal for the actuator that have been decimated, the sensor being configured to detect vibration of the object to be controlled, the drive signal being generated according to the output signal from the sensor.

(2) The information processing apparatus according to Item (1), in which the adaptive processing uses module information regarding a vibration control module.

(3) The information processing apparatus according to Item (1) or (2), in which the information processing apparatus transmits, by a communication circuit, the output signal from the sensor and the drive signal for the actuator that have been decimated to a parent apparatus, receives, by the communication circuit, information regarding the processing result of the adaptive processing using the transmitted information in the parent apparatus, and controls the gain of the drive signal for the actuator in reference to the received information.

(4) The information processing apparatus according to Item (2) or (3), in which the information processing apparatus receives, by the communication circuit, the module information regarding another apparatus and performs the adaptive processing by using the received information and the output signal from the sensor and the drive signal for the actuator that have been decimated.

(5) The information processing apparatus according to Item (3) or (4), in which the communication circuit establishes wireless communication.

(6) The information processing apparatus according to any one of Items (2) to (5),

in which the module information includes information indicating a state of the vibration control module, and

the control unit controls, according to the processing result of the adaptive processing, the gain of the drive signal for the actuator depending on the state of the vibration control module indicated by the module information.

(7) The information processing apparatus according to any one of Items (1) to (6), including:

a noise control processing unit configured to perform feedforward noise control processing involving sound control,

in which the sensor is also used as a reference sensor configured to detect a reference signal in the noise control processing unit.

(8) The information processing apparatus according to any one of Items (1) to (7), including:

an adder configured to acquire a sound signal for reproduction and add the acquired sound signal to the drive signal for the actuator.

(9) The information processing apparatus according to any one of Items (1) to (8), in which the adaptive processing performs overall optimization in a case where the vibration of the object to be controlled is controlled with use of multiple apparatuses.

(10) The information processing apparatus according to Item (9), in which the control unit sequentially adjusts gains of drive signals for actuators of the multiple apparatuses to optimum values.

(11) The information processing apparatus according to any one of Items (1) to (10), in which the drive signal for the actuator is generated by feedback noise control processing.

(12) The information processing apparatus according to any one of Items (1) to (11), in which the object to be controlled includes a frame or a window of a building or a vehicle.

(13) The information processing apparatus according to any one of Items (1) to (12), including:

the sensor;

a drive signal generation circuit configured to generate the drive signal for the actuator;

the actuator;

a decimation filter configured to decimate each of the output signal from the sensor and the drive signal for the actuator;

a memory configured to store module information regarding a vibration control module; and

a communication circuit configured to establish communication with another apparatus.

(14) An information processing apparatus including:

a control unit configured to perform control of
receiving, by a communication circuit, from a child apparatus configured to control a gain of a drive signal for an actuator that is used for vibration control of an object to be controlled, an output signal from a sensor and the drive signal for the actuator that have been decimated, the sensor being configured to detect vibration of the object to be controlled, the drive signal being generated according to the output signal from the sensor,
performing adaptive processing by using the received information, and
transmitting, by the communication circuit, information for controlling the gain of the drive signal for the actuator based on a processing result of the adaptive processing to the child apparatus.

(15) The information processing apparatus according to Item (14),

in which the child apparatus provided is more than one, and

the information processing apparatus performs the adaptive processing by aggregating pieces of information regarding the more than one child apparatus.

(16) The information processing apparatus according to Item (14) or (15),

in which the child apparatus provided is more than one, and

the information processing apparatus performs the adaptive processing sequentially on the more than one child apparatus.

(17) The information processing apparatus according to any one of Items (14) to (16), including:

a portable casing. (18) The information processing apparatus according to any one of Items (14) to (17), including:

a casing that is to be installed on a moving body. (19) An information processing method including:

by a control unit, controlling a gain of a drive signal for an actuator that is used for vibration control of an object to be controlled, according to a processing result of adaptive processing using an output signal from a sensor and the drive signal for the actuator that have been decimated, the sensor being configured to detect vibration of the object to be controlled, the drive signal being generated according to the output signal from the sensor.

(20) A program for causing a computer to execute an information processing method including

by a control unit, controlling a gain of a drive signal for an actuator that is used for vibration control of an object to be controlled, according to a processing result of adaptive processing using an output signal from a sensor and the drive signal for the actuator that have been decimated, the sensor being configured to detect vibration of the object to be controlled, the drive signal being generated according to the output signal from the sensor.

### REFERENCE SIGNS LIST

1, 1A, 1B, 1C, 1D: Noise control system

10: Child apparatus

11: FB-NC unit

12: Amplifier

13, 14: Decimation filter

15: Controller

16: Memory

17: Communication circuit

18: Adaptive processing unit

19: Adder

20: Parent apparatus

21: Parent apparatus-side communication circuit

22: Parent apparatus-side control unit

23: Parent apparatus-side memory

30: Noise canceling apparatus

40: FF-NC apparatus

41: FF communication circuit

42: FF-NC unit

A: Actuator

S: Sensor

SP: Sound output apparatus

T: Object to be controlled

1. An information processing apparatus comprising:
a control unit configured to control a gain of a drive signal for an actuator that is used for vibration control of an object to be controlled, according to a processing result of adaptive processing using an output signal from a sensor and the drive signal for the actuator that have been decimated, the sensor being configured to detect vibration of the object to be controlled, the drive signal being generated according to the output signal from the sensor.

2. The information processing apparatus according to claim 1, wherein the adaptive processing uses module information regarding a vibration control module.

3. The information processing apparatus according to claim 1, wherein the information processing apparatus transmits, by a communication circuit, the output signal from the sensor and the drive signal for the actuator that have been decimated to a parent apparatus, receives, by the communication circuit, information regarding the processing result of the adaptive processing using the transmitted information in the parent apparatus, and controls the gain of the drive signal for the actuator in reference to the received information.

4. The information processing apparatus according to claim 2, wherein the information processing apparatus receives, by a communication circuit, the module information regarding another apparatus and performs the adaptive processing by using the received information and the output signal from the sensor and the drive signal for the actuator that have been decimated.

5. The information processing apparatus according to claim 3, wherein the communication circuit establishes wireless communication.

6. The information processing apparatus according to claim 2,
wherein the module information includes information indicating a state of the vibration control module, and
the control unit controls, according to the processing result of the adaptive processing, the gain of the drive signal for the actuator depending on the state of the vibration control module indicated by the module information.

7. The information processing apparatus according to claim 1, comprising:
a noise control processing unit configured to perform feedforward noise control processing involving sound control,
wherein the sensor is also used as a reference sensor configured to detect a reference signal in the noise control processing unit.

8. The information processing apparatus according to claim 1, comprising:
an adder configured to acquire a sound signal for reproduction and add the acquired sound signal to the drive signal for the actuator.

9. The information processing apparatus according to claim 1, wherein the adaptive processing performs overall optimization in a case where the vibration of the object to be controlled is controlled with use of multiple apparatuses.

10. The information processing apparatus according to claim 9, wherein the control unit sequentially adjusts gains of drive signals for actuators of the multiple apparatuses to optimum values.

11. The information processing apparatus according to claim 1, wherein the drive signal for the actuator is generated by feedback noise control processing.

12. The information processing apparatus according to claim 1, wherein the object to be controlled includes a frame or a window of a building or a vehicle.

13. The information processing apparatus according to claim 1, comprising:
the sensor;
a drive signal generation circuit configured to generate the drive signal for the actuator;
the actuator;
a decimation filter configured to decimate each of the output signal from the sensor and the drive signal for the actuator;
a memory configured to store module information regarding a vibration control module; and
a communication circuit configured to establish communication with another apparatus.

14. An information processing apparatus comprising:
a control unit configured to perform control of
receiving, by a communication circuit, from a child apparatus configured to control a gain of a drive signal for an actuator that is used for vibration control of an object to be controlled, an output signal from a sensor and the drive signal for the actuator that have been decimated, the sensor being configured to detect vibration of the object to be controlled, the drive signal being generated according to the output signal from the sensor,
performing adaptive processing by using the received information, and
transmitting, by the communication circuit, information for controlling the gain of the drive signal for the actuator based on a processing result of the adaptive processing to the child apparatus.

15. The information processing apparatus according to claim 14,
wherein the child apparatus provided is more than one, and
the information processing apparatus performs the adaptive processing by aggregating pieces of information regarding the more than one child apparatus.

16. The information processing apparatus according to claim 14,
wherein the child apparatus provided is more than one, and
the information processing apparatus performs the adaptive processing sequentially on the more than one child apparatus.

17. The information processing apparatus according to claim 14, comprising:
a portable casing.

18. The information processing apparatus according to claim 14, comprising:
a casing that is to be installed on a moving body.

19. An information processing method comprising:
by a control unit, controlling a gain of a drive signal for an actuator that is used for vibration control of an object to be controlled, according to a processing result of adaptive processing using an output signal from a sensor and the drive signal for the actuator that have been decimated, the sensor being configured to detect vibration of the object to be controlled, the drive signal being generated according to the output signal from the sensor.

20. A program for causing a computer to execute an information processing method including
by a control unit, controlling a gain of a drive signal for an actuator that is used for vibration control of an object to be controlled, according to a processing result of adaptive processing using an output signal from a sensor and the drive signal for the actuator that have been decimated, the sensor being configured to detect vibration of the object to be controlled, the drive signal being generated according to the output signal from the sensor.
